(19) United States
(12) Patent Application Publication
(10) Pub. No.: US 2021/0168269 A1
(43) Pub. Date: Jun. 3, 2021

(54) VEHICLE ASSISTANCE SYSTEMS

(71) Applicant: 3M INNOVATIVE PROPERTIES COMPANY, St. Paul, MN (US)

(72) Inventors: John A. WHEATLEY, Stillwater, MN (US); Gilles J.B. BENOIT, Minneapolis, MN (US); John D. LE, Woodbury, MN (US); Zhisheng YUN, Sammamish, WA (US); Jonah SHAVER, St. Paul, MN (US); Susannah C. CLEAR, Hastings, MN (US); Timothy J. NEVITT, Red Wing, MN (US); Kui CHEN-HO, Woodbury, MN (US); Kenneth L. SMITH, White Bear Lake, MN (US); David J.W. AASTUEN, Shoreview, MN (US)

(21) Appl. No.: 17/263,389

(22) PCT Filed: Jul. 29, 2019
(86) PCT No.: PCT/IB2019/056445

§ 371 Date: Jan. 26, 2021

Related U.S. Application Data
(60) Provisional application No. 62/712,791, filed on Jul. 31, 2018.

(51) Int. Cl. H04N 5/225; G02B 5/20; G02B 27/28; G06K 9/62; G06K 9/00; H04N 7/18; G08G 1/0968

(52) U.S. Cl. CPC H04N 5/2254; G02B 5/208; G02B 27/288; G08G 1/0968; G06K 9/6202; G06K 9/00791; H04N 7/18; G02B 5/201

(57) ABSTRACT

The disclosure describes an example vehicle assistance system including a light sensor, a pixelated filter array adjacent the light sensor, and a full-field optically-selective element adjacent the pixelated filter array. The optically-selective element is configured to selectively direct an optical component of light incident on the optically-selective element across the pixelated filter array to the light sensor.

### TECHNICAL FIELD

The disclosure describes vehicle assistance systems, in particular, optical vehicle assistance systems.

### BACKGROUND

Automated driving technology makes use of optical sensor systems to detect roadway objects which can include infrastructure, other vehicles, or pedestrians. Increasing the range of detectability, improving signal to noise, and improving the recognition of objects continue to be fields of development. Systems that can provide at a distance, conspicuity, identification, and data via optical sensor systems, while being substantially visually imperceptible, may be advantageous. For example, signs may serve a dual purpose, where the sign may be visually read in the traditional way, and simultaneously the optical system can sense an invisible code that assists an onboard driving system with automated driving.

Other industry problems regarding optical sensors include the need to improve detection in adverse conditions that may affect light path and quality, which can cause signal to noise problems for the detection of infrastructure, vehicles, or pedestrians.

### SUMMARY

The disclosure describes an example vehicle assistance system including a light sensor, a pixelated filter array adjacent the light sensor, and a full-field optically-selective element adjacent the pixelated filter array. The optically-selective element is configured to selectively direct an optical component of light incident on the optically-selective element across the pixelated filter array to the light sensor. In some examples, the vehicle includes a land, sea, or air vehicle.

The disclosure describes an example technique including receiving, by a full-field optically-selective element of a vehicle assistance system, a light signal from an object. The example technique includes selectively directing, by the full-field optically-selective element, an optical component of the light signal through a pixelated filter array to a light sensor. A computing device may receive an image data signal from the image sensor in response to the light signal, compare the image data signal with a plurality of reference images in a lookup table, and generate, in response to the comparison, an output signal.

The details of one or more aspects of the invention are set forth in the accompanying drawings and the description below. Other features, objects, and advantages of the invention will be apparent from the description and drawings, and from the claims.

### BRIEF DESCRIPTION OF DRAWINGS

The foregoing and other aspects of this invention are made more evident in the following Detailed Description, when read in conjunction with the attached Figures.

FIG. 1 is a conceptual diagram of an example vehicle assistance system including a light sensor, a pixelated filter array, and a full-field optically-selective element.

FIG. 2 is a conceptual diagram of an example system including the vehicle assistance system of FIG. 1 for detecting light deflected by an object.

FIG. 3 is a conceptual diagram of an example system including a vehicle assistance system including cascaded optically-selective elements for detecting light deflected by an object.

FIG. 4 is a conceptual diagram of an example optically-selective element including a cross-type dichroic splitter.

FIG. 5A is a conceptual diagram of an example optically-selective element including a trichroic prism.

FIG. 5B is a conceptual diagram of an example optically-selective element including a trichroic prism.

FIG. 6A is a conceptual diagram of a Bayer color filter array.

FIG. 6B is a conceptual diagram of a red/clear/clear/clear (RCCC) color filter array.

FIG. 6C is a conceptual diagram of a monochrome filter array.

FIG. 6D is a conceptual diagram of a red/clear/clear/blue (RCCB) color filter array.

FIG. 6E is a conceptual diagram of a red/green/clear/blue (RGCB) color filter array.

FIG. 7A is a conceptual diagram of a full-field optically-selective element configured to reflect an infrared wavelength band and transmit visible light.

FIG. 7B is a conceptual diagram of a full-field optically-selective element configured to reflect a first infrared wavelength band and transmit a second infrared wavelength band and visible light.

FIG. 7C is a conceptual diagram of a full-field optically-selective element configured to reflect a first and a second infrared wavelength band and transmit a third infrared wavelength band and visible light.

FIG. 7D is a conceptual diagram of a full-field optically-selective element configured to reflect an infrared wavelength band and transmit visible light and an ultraviolet wavelength band.

FIG. 7E is a conceptual diagram of a full-field optically-selective element configured to reflect an ultraviolet wavelength band and transmit visible light and an infrared wavelength band.

FIG. 7F is a conceptual diagram of a full-field optically-selective element configured to reflect an infrared wavelength band and an ultraviolet wavelength band and transmit visible light.

FIG. 7G is a conceptual diagram of a full-field optically-selective element configured to reflect first red and green wavelength bands and transmit second and green wavelength bands and a blue wavelength band.

FIG. 7H is a conceptual diagram of a full-field optically-selective element configured to reflect an s-polarized red wavelength band, and transmit a p-polarized red wavelength bands, and transmit green and blue wavelength bands.

FIG. 8 is a conceptual diagram of an example optically-selective element including a lens.

FIG. 9 is a conceptual diagram of an example field optically-selective element including a curved reflective interface.

FIG. 10 is a conceptual diagram of an example optically-selective element including an inclined reflector.

FIG. 11A is a conceptual diagram of a vehicle including an automated driver assistance system (ADAS).

FIG. 11B is a conceptual partial front view of the vehicle of FIG. 11A.

FIG. 12 is a flowchart of an example technique for sensing, by a vehicle assistance system, an optical signal.

FIG. 13 is a conceptual diagram of coded pattern readable by a vehicle assistance system.

FIG. 14 is a chart showing a spectrum of an example narrow band blocking multilayer optical film (MOF).

FIG. 15A is a chart showing a relationship between wavelength, polar angle, and reflectance of the MOF of FIG. 14 in air.

FIG. 15B is a chart showing a relationship between wavelength, polar angle, and transmittance of the MOF of FIG. 14 in air.

FIG. 16A is a chart showing a relationship between wavelength, polar angle, and reflectance of the MOF of FIG. 14 in glass.

FIG. 16B is a chart showing a relationship between wavelength, polar angle, and transmittance of the MOF of FIG. 14 in glass.

FIG. 16C is a chart showing a relationship between wavelength, polar angle, and p-polarized transmittance of the MOF of FIG. 14 in glass.

FIG. 16D is a chart showing a relationship between wavelength, polar angle, and s-polarized transmittance of the MOF of FIG. 14 in glass.

FIG. 17 is a chart showing a spectrum of an example dual band blocking multilayer optical film (MOF).

FIG. 18A is a chart showing a relationship between wavelength, polar angle, and reflectance of the MOF of FIG. 17 in air.

FIG. 18B is a chart showing a relationship between wavelength, polar angle, and transmittance of the MOF of FIG. 17 in air.

It should be understood that features of certain Figures of this disclosure may not necessarily be drawn to scale, and that the Figures present non-exclusive examples of the techniques disclosed herein.

### DETAILED DESCRIPTION

The disclosure describes vehicle navigation systems. In some examples, vehicle navigation systems according to the disclosure may be used to decode patterns or optical signatures of optically encoded articles, for example, navigation assistance or traffic sign pattern or objects.

Vehicle assistance systems may include automated driver assistance systems (ADAS). Object sensing and detection in ADAS systems, for example, by ADAS cameras or optical sensors may pose challenges in terms of spectral resolution and polarization. In some examples, systems and techniques according to the disclosure may provide a way to increase signal to noise in a compact and practical way that is compatible with current imager systems. Optical filters may be combined with imager pixel arrays. In some examples, beamsplitters may be used to enable high efficiency, compact designs. In some examples, an a beamsplitter may enable high spatial resolution for the wavelength being sensed or analyzed. For example, dedicating an entire imager to a particular wavelength or band (for example, centered at 840 nm), may provide a high resolution of variation for that wavelength or band (for example 840 nm) over the entire image, in contrast with an imager sensing different bands or wavelengths of which only a few pixels may be associate with the wavelength or band of interest.

In some examples, a system functions as a transceiver and includes an optical filter component that modifies the wavelength of light incident on an imaging system enabling it to decode patterns or optical signatures of optically encoded articles. The system may include an optically-selective filter (for example, wavelength-selective, polarization-selective, or both) that selectively blocks visible or non-visible light (UV and/or IR) wavelengths or linear or circular polarization states to enhance the detection of items such as IR coded signs or unique spectral features of objects, for example, objects encountered by or in the vicinity of a land, air, or sea vehicle. The filter can be used as a freestanding element or as a beamsplitter component. The filter may be used in combination with the one or more filter of an imager pixel array to analyze images having non-visible spectral features. Unique signatures can be compared to a look up table of known signatures and meanings.

In some examples, the angular wavelength shifting properties of a multilayer optical film (MOF) may be used to transform a beamsplitter imager into a hyperspectral camera in vehicle assistance systems. The MOF may include birefringement MOFs. Such MOFs which may exhibit good off-angle performance and relatively high angle shift. For example, an angle-shifting optically-selective filter may be immersed in a beamsplitter in optical communication with an imager. In some examples, a pixel array adjacent the imager includes at least one clear pixel. The pixel array may be in contact with the imager, or spaced from, but optically coupled with, the imager. The system further includes an angle-limiting element for introducing light having a range angles of incidence at the filter surface. The system may include two imagers, one primarily for spectroscopy and the other for imaging. This may enable a high efficiency imaging spectrometer or spectropolarimeter for ADAS or vehicle assistance systems. Thus, challenges in detection for ADAS cameras in terms of spectral resolution and polarization may be addressed. For example, both image information and spectral/polarization analysis of a scene may be performed.

In this disclosure, “visible” refers to wavelengths in a range between about 400 nm and about 700 nm, and “infrared” (IR) refers to wavelengths in a range between about 700 nm and about 2000 nm, for example, wavelengths in a range between about 800 nm and about 1200 nm, and includes infrared and near-infrared. Ultraviolet (UV) refers to wavelengths below about 400 nm.

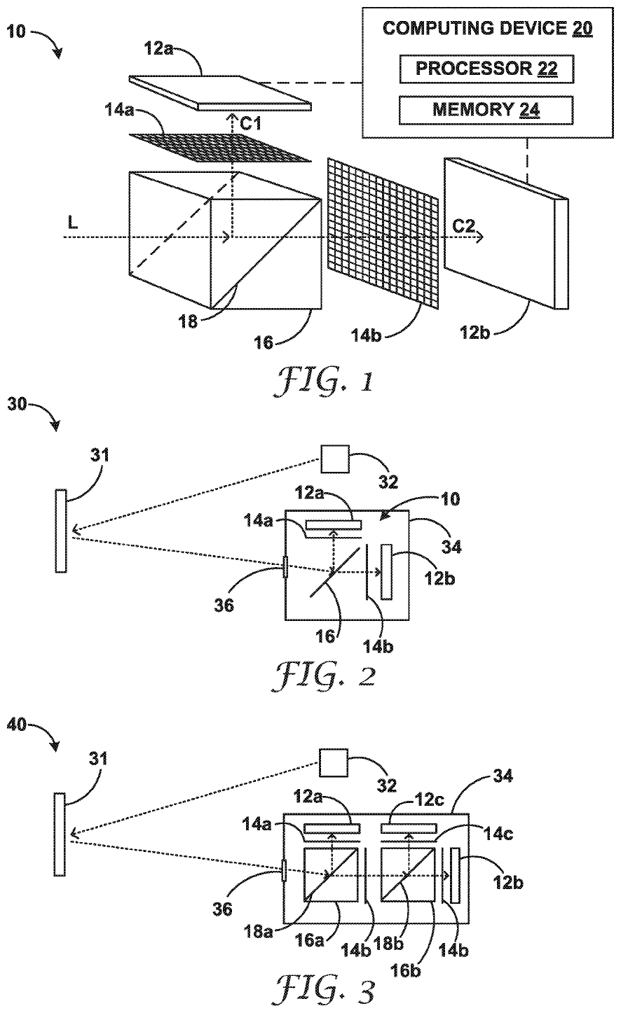

FIG. 1 is a conceptual diagram of an example vehicle assistance system 10 including a light sensor 12a, a pixelated filter array 14a, and a full-field optically-selective element 16 (also referred to as a “wavelength selective element”). The term “full-field” indicates that optically-selective element 16 optically covers an entirety of light sensor 12a and pixelated filter array 14a, such that all light incident on light sensor 12a or pixelated filter array 14a passes through optically-selective element 16. For example, light from optically-selective element 16 may be output parallel, angled, convergent, or divergent, or otherwise directed to substantially optically cover light sensor 12a or pixelated filter array 14a. In some examples, system 10 may include one or more optical elements to guide light from optically-selective element 16 to optically spread across or cover light sensor 12a or pixelated filter array 14a. Pixelated filter array 14a is adjacent (for example, in contact with, or spaced from and optically coupled with) light sensor 12a. Optically-selective element 16 is adjacent (for example, in contact with, or spaced from and optically coupled with) pixelated filter array 14a.

Optically-selective element 16 may include an optical filter, a multilayer optical film, a microreplicated article, a dichroic filter, a retarder or waveplate, at least one beamsplitter, or combinations thereof. Optically-selective element 16 may include glass, one or more polymers, or any suitable optical material or combinations thereof. In the example shown in FIG. 1, full-field optically-selective element 16 includes a beamsplitter. In some examples, the beamsplitter includes a polarization beamsplitter, a wavelength beamsplitter, a dichroic prism, a trichroic prism, or combinations thereof. The beamsplitter includes two triangular prisms joined (for example, by an adhesive) at their bases forming interface 18. A dichroic coating or layer may be provided at interface 18 to split an arriving light signal into two or more spectral components, for example, components having different wavelengths or polarization states. Optically-selective element 16 may be wavelength-selective, polarization-selective, or both. An optical coating or filter may be provided on or adjacent (for example, in contact with) one or more faces of optically-selective element 16 to filter, for example, selectively absorb, transmit, or change predetermined wavelengths or polarization states. In some examples, the optical coating may include a waveplate or retarder, for example, a half-wave retarder or quarter-wave retarder, to change the polarization direction, or to interchange linearly polarization to circular polarization. In some examples, the optical coating includes a spatially variant wavelength-selective filter. In this disclosure, the term “polarization states” includes linear and circular polarization states. In some examples, system 10 includes at least one polarizing filter across an optical path arriving at light sensor 12a. In some examples, optically-selective element 16 includes at least one of an ultraviolet-(UV) transmitting, visible-reflecting multilayer film filter; an ultraviolet-(UV) reflecting, visible-transmitting multilayer film filter; an edge filter; a transmission notch filter; a reflective notch filter; or a multiband filter.

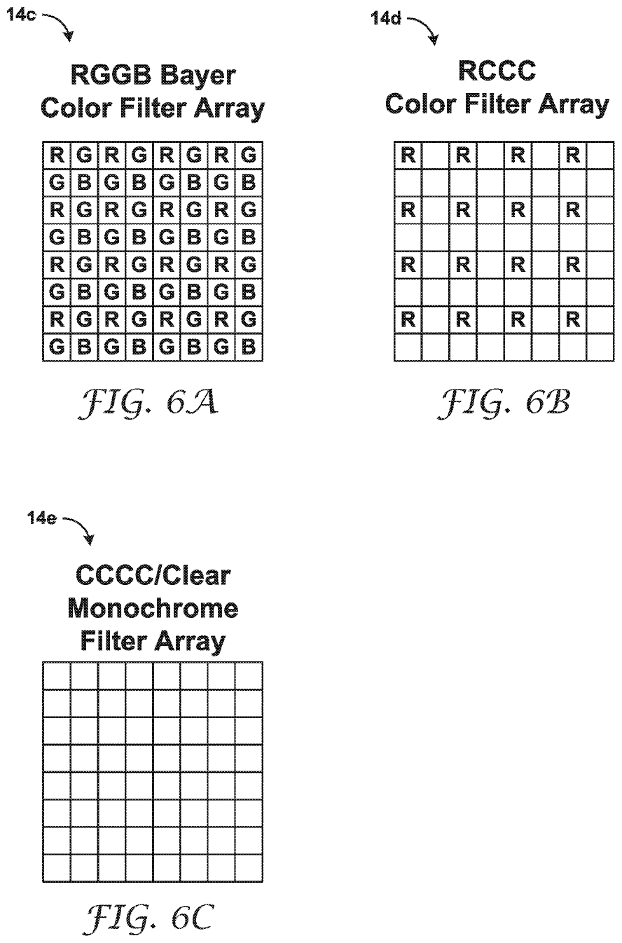

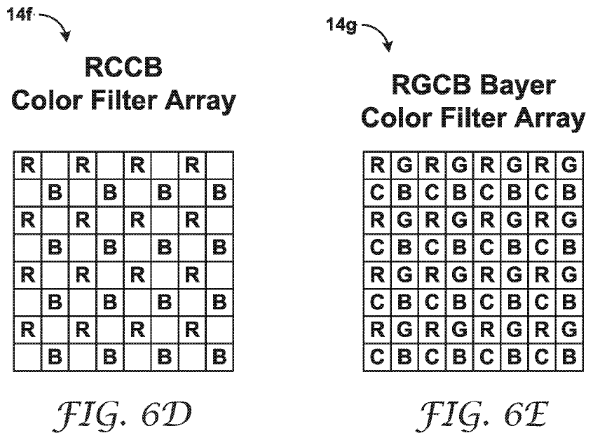

As shown in FIG. 1, optically-selective element 16 splits a light signal L incident on optically-selective element 16 into two optical components, C1 and C2, and selectively directs optical component C1 of light L through pixelated filter array 14a to light sensor 12a. In some examples, the second optical component C2 is discarded. In other examples, second optical component C2 is sent to another light sensor. For example, light sensor 12a may include a first light sensor, and system 10 may include a second light sensor 12b. Likewise, pixel filter array 14a may include a first pixel filter array, and system 10 may include a second pixel filter array 14b. Thus, optically-selective element 16 may selectively direct second optical component C2 through second pixelated filter array 14b to second light sensor 12b. Pixelated filter arrays 14a, 14b may cause predetermined components of light to be incident on light sensors 12a and 12b in discrete regions, or pixels. Thus, each pixel may include sub-pixels for one or more predetermined channels or components of light. For example, each pixel of pixelated filter array 14a, 14b may include one or more of red, green, blue, or clear sub-pixels. Some examples of sub-pixel configurations of pixelated filter arrays are described with reference to FIGS. 6A to 6E.

In some examples, pixelated filter arrays 14a, 14b may be respectively integrated with light sensors 12a and 12b, for example, fabricated in the same integrated chip. Thus, pixelated filter arrays 14a, 14b may be grown on or otherwise in immediate contact with light sensors 12a and 12b.

First and second optical components C1 and C2 may differ in at least one wavelength band or polarization state, or combinations thereof, with C2 typically being an optical complement to C1. In some examples, first optical component C1 includes at least a first ultraviolet, visible, or infrared wavelength band (centered at λ₁), and second optical component C2 includes at least a second ultraviolet, visible, or infrared band (centered at λ₂) different from the first band. In some examples, the first wavelength band has a bandwidth less than 200 nm, and wherein the second wavelength band comprises the spectral complement of the first wavelength band. In some examples, the first wavelength band has a bandwidth less than 100 nm, or less than 50 nm. In some examples, the first wavelength band includes at least one visible wavelength band, and wherein the second wavelength band includes at least one near-infrared band. In some examples, the first wavelength band includes at least one visible wavelength band and at least a first near-infrared band, and the second wavelength band includes at least a second near-infrared band. In some examples, the first wavelength band includes at least one visible wavelength band, and the second wavelength band includes at least one UV band. In some examples, the first wavelength band includes at least a first one visible wavelength band, and the second wavelength band includes at least a second visible wavelength band. In some examples, first optical component C1 includes a first polarization state, and second optical component C2 includes at least a second polarization state different from the first polarization states. In some examples, first light sensor 12a functions as an imaging sensor, and second light sensor 12b functions as a hyperspectral sensor.

In some examples, optically-selective element 16 includes an angle-limiting optical element. In some examples, in addition to, or instead of, the angle-limiting optical element, optically-selective element 16 includes an angle-spreading optical element. The angle-limiting or angle-spreading element may include a refractive element, a diffractive element, a lens, a prism, a microreplicated surface or article, or combinations thereof. In some examples, optically-selective element 16 including an angle-spreading optical element may function as a spectrometer, and emit different wavelengths at different angles.

System 10 may include a computing device 20. Light sensors 12a, 12b may be in electronic communication with computing device 20. Computing device 20 may include a processor 22 and a memory 24. Processor 22 may be configured to implement functionality and/or process instructions for execution within computing device 20. For example, processor 22 may be capable of processing instructions stored by a storage device, for example, memory 24, in computing device 20. Examples of processor 22 may include, any one or more of a microprocessor, a controller, a digital signal processor (DSP), an application specific integrated circuit (ASIC), a field-programmable gate array (FPGA), or equivalent discrete or integrated logic circuitry. Memory 24 may include a lookup table that includes a plurality of reference images.

Computing device 20 may receive at least one image data signal from light sensors 12a, 12b, and processor 22 may be configured to compare the image data signal with the plurality of reference images. Processor 22 may be configured to, based on the comparison, generate an output signal. Computing device 20 may send the output signal to a controller of the vehicle to cause the controller to take an action based on the output signal. The action may include a physical action, a communications action, an optical transmission, or controlling or activating a sensor. In some examples, computing device 20 may itself be a controller for the vehicle. For example, computing device 20 may direct navigation, and control movement of the vehicle. The output signal may be configured to one or more of adjust a navigation action, cause retrieval over a communications network of a response signal, cause retrieval over the communications network of vehicle environment information, or cause sending of a communication signal over the communications network to a target vehicle. The sensing and or communication may take place with another vehicle, but can also take place with part of the infrastructure (such as a sign), or with a person. In some examples, computing device 20 may communicate with a transceiver that can be on a different vehicle, an infrastructure component, or on a person.

FIG. 2 is a conceptual diagram of an example system 30 including vehicle assistance system 10 of FIG. 1 for detecting light deflected by an object 31. Object 31 may include any object encountered by or in the vicinity of a land, air, or sea vehicle. For example, object 31 may include traffic signs, construction equipment or signs, pedestrian jackets or clothing, retroreflective signs, billboards, advertisements, navigation markers, milestones, bridges, pavement, road markings, or the like. In some examples, system 30 includes a light transmitter 32 configured to transmit light towards object 31. Thus, light sensor 12a, 12b may be configured to sense light reflected or retroreflected by object 31 from light transmitter 32. In some examples, system 10 may include a particular light transmitter, and object 31 may reflect ambient light, for example, sunlight, or light from multiple sources, towards object 31. In some examples, system 30 includes optically-selective element 16 including an optical filter, instead of a beamsplitter, as shown in FIG. 2.

As shown in FIG. 2, in some examples, system 30 includes an enclosure 34. Enclosure 34 may include a rigid housing, or a semi-rigid or soft enclosure enclosing light sensors 12a, 12b, pixelated filter array 14a, 14b, and optically-selective element 16. Enclosure 34 may protect the optical components from stray light, and may be substantially opaque, so that light sensors 12a, 12b are protective from inadvertent exposure to light. In some examples, enclosure 34 defines an optical window 36 to selectively admit light to optically-selective element 16 and ultimately to light sensors 12a, 12b. Optical window 36 may include a lens (for example, a fish-eye lens), a refractive element, an optical filter, or be substantially optically clear. Enclosure 34 may be secured or mounted at a suitable location, region, or component of a vehicle, for example, an air, sea, or land vehicle. In some examples, enclosure 34 may be secured such that optical window 36 faces a predetermined orientation, for example, in a forward direction, a backward direction, or sideways, relative to a direction of travel of the vehicle. In some examples, multiple enclosures 34 may enclose multiple systems 10 or 30 at different locations or oriented in different directions about or on the vehicle. While systems 10 or 30 may include single optically-selective element 16, in other examples, example systems may include two or more optically-selective elements, for example, as described with reference to FIG. 3.

FIG. 3 is a conceptual diagram of an example system 40 including a vehicle assistance system including cascaded optically-selective elements 16a, 16b for detecting light deflected by object 31. System 40 is substantially similar to example system 30, but includes two optically-selective elements 16a and 16b substantially similar to single optically-selective element 16 described with reference to FIGS. 1 and 2. System 40 includes three light sensors 12a, 12b, 12c, and three pixelated filter arrays 14a, 14b, 14c. First optically-selective element 16a splits incident light into two components, the first component being directed through first pixelated filter array 14a to first light sensor 12a. The second component is directed to second optically-selective element 16b, which splits the second component into two further components (third and fourth components), the third component being selectively directed through second pixelated filter array 14b to second light sensor 12b, and the fourth component being selectively directed through third pixelated filter array 14c to third light sensor 12c. System 40 may include three or more optically-selective elements and four or more light sensors and pixelated filter arrays, likewise splitting and selectively directing a series of light components to respective sensors. The different components may differ in at least one wavelength band or polarization state.

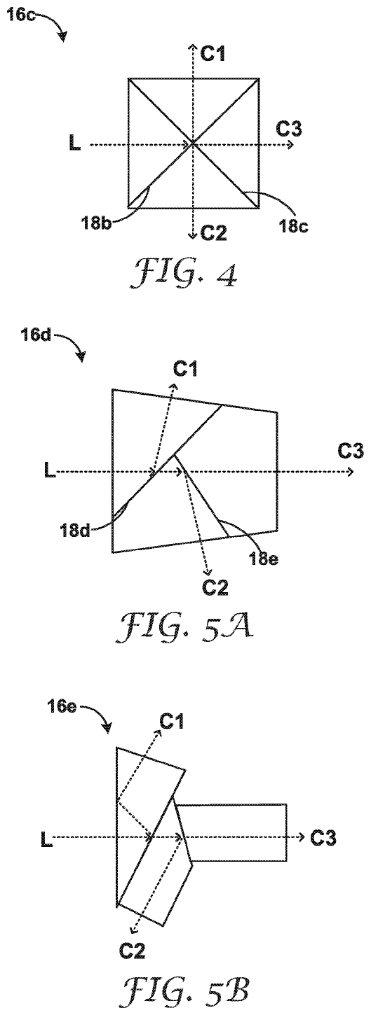

Instead of, or in addition to, a beamsplitter, systems 10, 30, or 40 may include other optically-selective elements, for example, those described with reference to FIGS. 4 and 5.

FIG. 4 is a conceptual diagram of an example optically-selective element 16c including a cross-type dichroic splitter. The cross-type dichroic splitter (also known as an “X-cube” or “RGB prism”, for example, available from WTS Photonics Technology Co., Ltd, Fuzhou, China) may be defined by two dichroic interfaces 18b and 18c embedded in glass or another suitable optical medium. In some examples, interface 18b may define a red and green filter, while interface 18c may define a cyan filter transverse to interface 18b. As seen in FIG. 4, optically-selective element 16c may substantially direct three components C1, C2, and C3 of incident light L along three distinct directions. In some examples, three respective light sensors may separately detect the three components. C1, C2, and C3 may correspond to any suitable predetermined combination of UV, visible, or IR wavelengths, and polarization states. In some examples, C1, C2, and C3 may correspond to red, green, and blue channels.

FIG. 5A is a conceptual diagram of an example optically-selective element 16d including a trichroic prism. The trichroic prism may be defined by glass or any suitable optical medium, and include two dichroic interfaces 18d and 18e at a predetermined angle. Dichroic interfaces 18d and 18e may act as dichroic filters and direct different components, for example, C1, C2, and C3 of incident light L, along three distinct directions. In some examples, three respective light sensors may separately detect the three components. C1, C2, and C3 may correspond to any suitable predetermined combination of UV, visible, or IR wavelengths (for example, bands centered at predetermined wavelengths λ₁, λ₂, and λ₃) and polarization states. In some examples, C1, C2, and C3 may correspond to red, green, and blue channels.

FIG. 5B is a conceptual diagram of an example optically-selective element 16e including a trichroic prism. The trichroic prism may be defined by glass or any suitable optical medium, and include dichroic interfaces between prismatic or refractive elements. The dichroic interfaces may act as dichroic filters and direct different components, for example, C1, C2, and C3 of incident light L, along three distinct directions. In some examples, three respective light sensors may separately detect the three components. C1, C2, and C3 may correspond to any suitable predetermined combination of UV, visible, or IR wavelengths (for example, bands centered at predetermined wavelengths λ₁, λ₂, and λ₃) and polarization states. In some examples, C1, C2, and C3 may correspond to red, green, and blue channels.

Instead of, or in addition to, pixelated filter arrays 14a, 14b, systems 10, 30, or 40 may include other pixelated filter arrays, for example, those described with reference to FIGS. 6A to 6E.

FIG. 6A is a conceptual diagram of a Bayer color filter array. A Bayer color filter array includes a red, a blue, and two green pixels in each block (RGGB). While a particular relative arrangement of the red, green, and blue pixels is shown in FIG. 6A, other geometric arrangements may also be used. A Bayer color filter array yields information about the intensity of light in red, green and blue wavelength regions by passing these wavelengths to discrete regions of an adjacent image sensor. The raw image data captured by the image sensor is then converted to full-color image by a demosaicing algorithm with intensities of all three primary colors (red, green, blue) represented at each pixel or block. A Bayer color filter array has 25% R, 25% B, and 50% G pixels.

FIG. 6B is a conceptual diagram of a red/clear/clear/clear (RCCC) color filter array. For vehicle assistance systems or advanced driver assistance systems (ADAS), multiple cameras may capture the scene around a vehicle to assist during transport. Typical machine vision algorithms may use or analyze only the intensity of the light. But for ADAS, special color filter arrays may be produced to provide color information. One useful color information channel is in the red channel, which helps localize the region of interest of the image, such as traffic light, car rear-light, etc. Red/clear (RCCC) color filter arrays may be used for vehicle assistance use. Unlike Bayer sensors, RCCC sensors use clear filters instead of the blue and the two green filters in the 2×2 pixel pattern, and have 75% clear pixels which give the light intensity information and no color information. 25% of the pixels have RED color information. The red filter remains the same. A “clear filter” is the same concept as monochrome sensors. The advantage of this format is that it may provide more sensitivity to light and therefore may work better in dark conditions. Thus, in some examples, pixelated filter arrays according to the disclosure may include at least one clear pixel, for example, a plurality of clear pixels.

FIG. 6C is a conceptual diagram of a monochrome filter array. A monochrome array has 100% “clear” pixels which give light intensity information and no color information. This is acceptable for either monochrome viewing or for analytics applications where no color information is required (for example, driver monitoring). The advantage of this format is that it provides more sensitivity to light and therefore may work better in dark conditions.

FIG. 6D is a conceptual diagram of a red/clear/clear/blue (RCCB) color filter array. RCCB is similar to Bayer (RGGB) with the exception that half of the pixels are clear instead of green. The advantage of this format is that clear pixels provide more low-light sensitivity, thus leading to lower noise. This format has potential to allow the same camera for visual as well as analytic application.

FIG. 6E is a conceptual diagram of a red/clear/clear/blue (RCCB) color filter array. RGCB is similar to Bayer (RGGB) with the exception that half of the green pixels are clear instead of green. The advantage of this format is that clear pixels provide more low-light sensitivity, thus leading to lower noise. This format has potential to allow the same camera for visual as well as analytic application.

The clear pixels may be transmissive in one or more of visible, infrared, or ultraviolet wavelengths, or combinations thereof. In some example, the clear pixels are transmissive to substantially only visible wavelengths. In some examples, the clear pixels are transmissive to substantially only infrared wavelengths. In some examples, the clear pixels are transmissive to substantially only ultraviolet wavelengths. In some examples, the clear pixels are transmissive to substantially only visible and infrared wavelengths.

While different color filter arrays are available, systems that do not include an optically-selective element may present problems. For example, in the absence of an optically-selective element, a vehicle assistance system or ADAS may exhibit limited spectral resolution in IR and UV, a lack of polarization information, signal loss if a polarizer is used, loss of signal due to filtering, and poor contrast between channels.

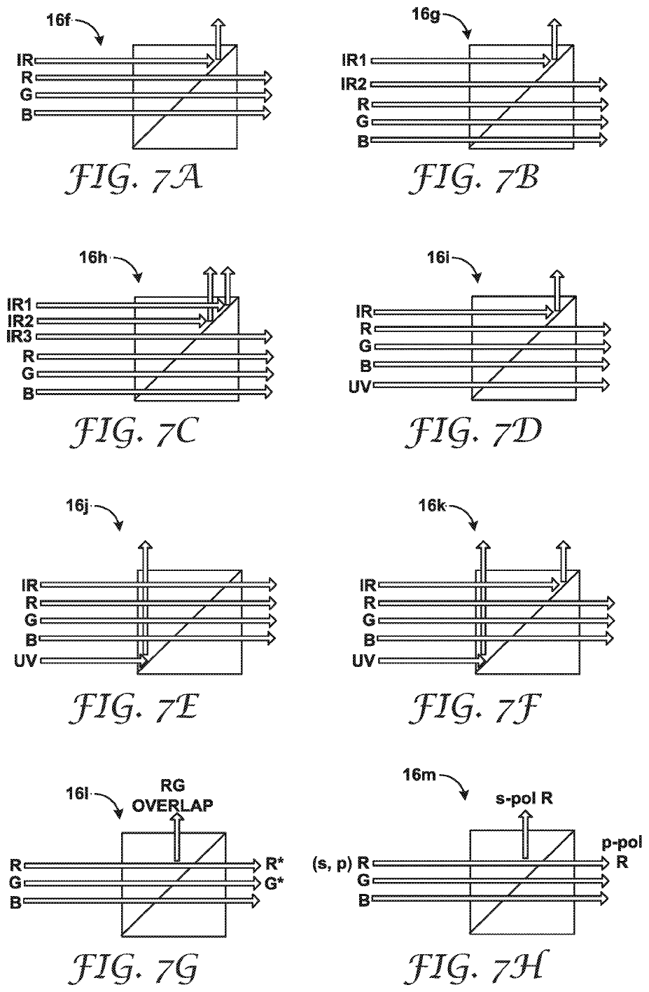

In example systems according to the disclosure, one or more optically-selective elements may address one or more of these problems, for example, by separating channels to provide better contrast, eliminating or attenuating interfering wavelengths, allowing improved spectral resolution in IR and UV, and yielding polarization information. Some examples, of splitting of light into different components by example wavelength selective elements is described with reference to FIGS. 7A through 7H.

FIG. 7A is a conceptual diagram of a full-field optically-selective element 16f configured to reflect an infrared wavelength band and transmit visible light. FIG. 7B is a conceptual diagram of a full-field optically-selective element 16f configured to reflect a first infrared wavelength band and transmit a second infrared wavelength band and visible light. FIG. 7C is a conceptual diagram of a full-field optically-selective element 16h configured to reflect a first and a second infrared wavelength band and transmit a third infrared wavelength band and visible light. FIG. 7D is a conceptual diagram of a full-field optically-selective element 16i configured to reflect an infrared wavelength band and transmit visible light and an ultraviolet wavelength band. FIG. 7E is a conceptual diagram of a full-field optically-selective element 16j configured to reflect an ultraviolet wavelength band and transmit visible light and an infrared wavelength band. FIG. 7F is a conceptual diagram of a full-field optically-selective element 16k configured to reflect an infrared wavelength band and an ultraviolet wavelength band and transmit visible light. FIG. 7G is a conceptual diagram of a full-field optically-selective element 16l configured to reflect first red and green wavelength bands and transmit second and green wavelength bands and a blue wavelength band. FIG. 7H is a conceptual diagram of a full-field optically-selective element 16m configured to reflect an s-polarized red wavelength band, and transmit a p-polarized red wavelength bands, and transmit green and blue wavelength bands. Detecting polarization with reduced or minimal signal loss is enabled by using a narrow band s-pol reflector. Image analysis between the two s- and p-polarized images can be used for polarization analysis of a scene. Detection of pavement conditions is one example such as determining if pavement is wet. Another example is eliminating surface glare so that the spectrum of a pavement marking can be analyzed.

While in the examples of FIGS. 7A to 7H, a filter is in the cube (diagonal interface), in other examples, a filter may be disposed on a surface of the cube, in addition, or instead of, to a filter on the cube diagonal. In some examples, the diagonal film may include be a half mirror, used in combination with a cube surface filter that that is wavelength selective. The filters may include narrow band reflective as well as narrow band transmission filters.

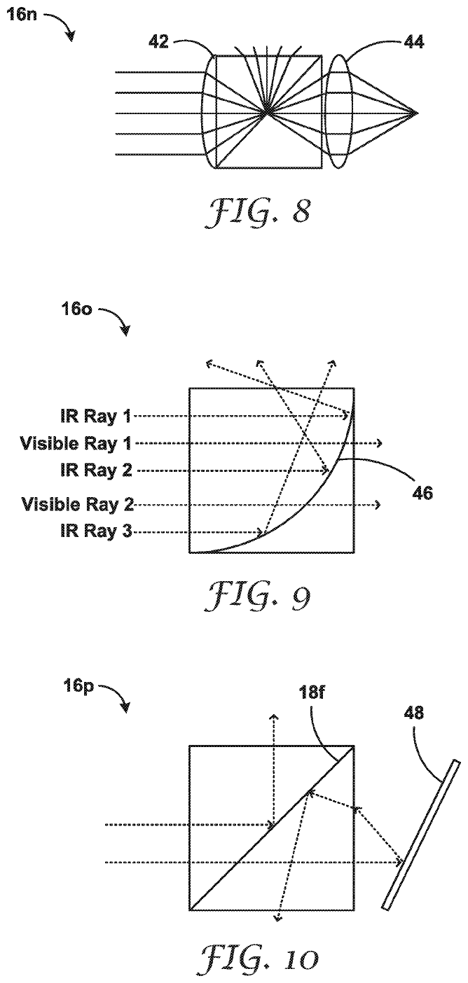

FIG. 8 is a conceptual diagram of an example optically-selective element 16m including a lens 42. Lens 42 creates a range of incidence angles on a filter in optically-selective element 16n (for example, a multilayer optical film), which results in wavelength shift directed upwards. The wavelength shift can be detected by an image sensor adjacent the upper face. A second lens 44 may converge light onto a second image sensor adjacent the right face of optically-selective element 16m.

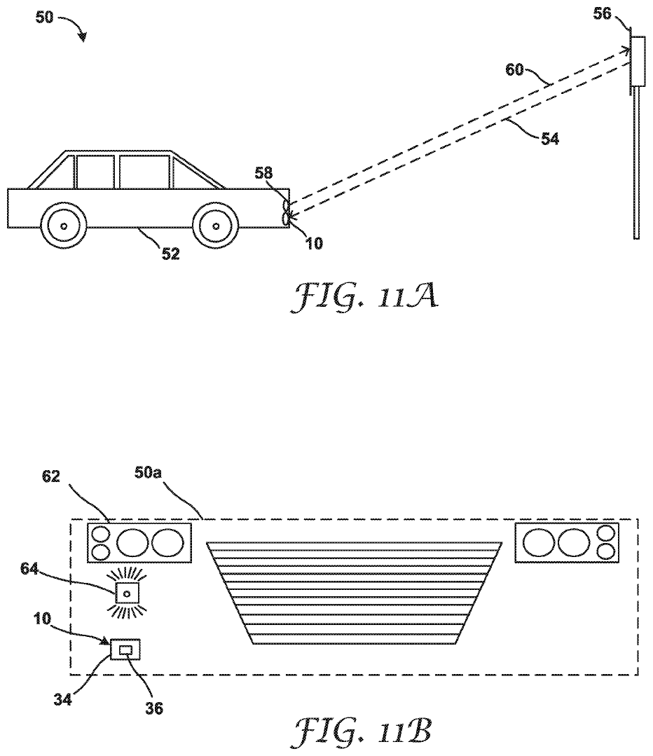

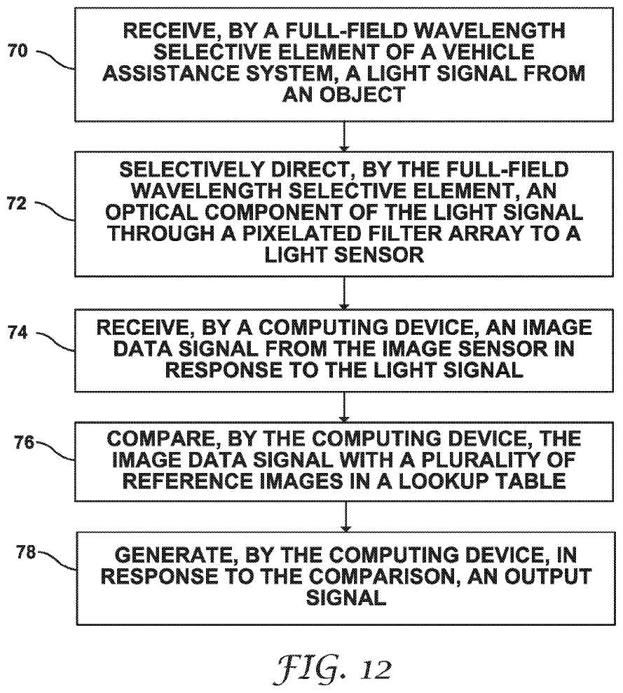

FIG. 9 is a conceptual diagram of an example field optically-selective element 16o including a curved reflective interface 46. In some examples, curved reflective interface 46 may include a curved multilayer optical film (MOF). The curvature creates a range of angles of incidence that are then mapped to pixel locations. Each pixel location senses the effect of different reflection spectrum. While one specific curve is illustrated in FIG. 9, interface 46 may be disposed along any suitable geometric curve, compound curve, surface, or compound surface, including linear segments, circular arcs, ellipsoidal arcs, parabolic or hyperbolic arcs, plane segments, spherical surfaces, ellipsoid surfaces, paraboloid surfaces, hyperboloid surfaces, freeform surfaces or arcs, or combinations thereof. In some examples, as shown in FIG. 9, interface 46 includes an IR-reflecting visible-transmitting film. The angular wavelength shift occurs in the IR and provides a ray spread to the top face, while visible light passes through the right face. Imagers can be disposed adjacent the respective faces to capture the separated components.

FIG. 10 is a conceptual diagram of an example optically-selective element 16p including an inclined reflector 48. Inclined reflector 48 may be used to create two incidence angles. In some examples, inclined reflector 48 may be curved, similar to curved interface 46. The inclined or curved reflector 48 may separate light into two components, as shown in FIG. 10. Optically-selective element 16o may include filter 18f at the diagonal interface.

FIG. 11A is a conceptual diagram of a vehicle 50 including an automated driver assistance system (ADAS). FIG. 11B is a conceptual partial front view of vehicle 50 of FIG. 11A. The ADAS may include system 10 described with reference to FIG. 1, or systems 30 or 40. For example, systems 10, 30, or 40 may be mounted or enclosed in an enclosure (for example, enclosure 34 or similar enclosures) secured to a body or frame 52 of vehicle 50. System 10 may detect light 54 deflected by an object 56. In some examples, vehicle 50 may include a light source 58 sending light 60 towards object 56 that is deflected by object 56 (for example, reflected or retroreflected) to system 10. Light source 58 may include headlights or vehicle lights 62, or a dedicated light source 64 distinct from headlights or vehicle lights 62 (or combinations thereof). While a car is shown in FIG. 11A, vehicle 50 may include any land, sea, or air vehicle.

FIG. 12 is a flowchart of an example technique for sensing, by a vehicle assistance system, an optical signal. The example technique of FIG. 12 is described with reference to system 10 of FIG. 1 and system 30 of FIG. 2. However, the example technique may be implement using any suitable system according to the disclosure. In some examples, the example technique includes receiving, by full-field optically-selective element 16 of vehicle assistance system 10, light signal L from object 31 (70). The example technique includes selectively directing, by optically-selective element 16, an optical component C1 of light signal L through pixelated filter array 14a to light sensor 12a (72).

The example technique includes receiving, by computing device 20, an image data signal from image sensor 12a in response to light signal L (74). In some examples, the image data signal may correspond to a single image captured at one instant of time. In other examples, the image data signal may include a series of images captured in real-time, near-real time, or at intermittent times. In some examples, light source 32 may illuminate object 31 with a light signal having a predetermined frequency or a predetermined temporal pattern, and object 31 may deflect a response signal having a response frequency or response temporal pattern. In some such examples, the receiving the light signal L (74) may be synchronized with, or asynchronous to, the light signal transmitted to object 31.

The example technique includes comparing, by computing device 20, the image data signal with a plurality of reference images in a lookup table (76). The comparing may be for a single image captured at a single instance of time, or may include a series of comparisons for a series of images captured in real-time, near-real time, or at intermittent times. In some examples, the lookup table may be implemented by or replaced with a machine learning module, for example, a deep-learning model, or a convolutional neural network, or a pattern recognition module. Thus, in some examples, entries of the lookup table may correspond to outputs of the machine learning module or pattern recognition module associated with images. In some examples, the light signal L may be generated by object 31 in response to a light signal having a spectrum S(λ) generated by light source 32. Image sensor 12a and pixelated filter array 14a may have a first wavelength transmission function T1(λ) Optically-selective element 16 may have a second transmission function T2(λ) Object 31 may have a reflection spectrum R(λ). In such examples, a component of signal L received by image sensor 12a may correspond to S(λ)*T1(λ)*T2(λ)*R(λ), and computing device 20 may compare S(λ)*T1(λ)*T2(λ)*R(λ) with elements of a lookup table.

The example technique includes generating, by computing device 20, in response to the comparison, an output signal (78). In some examples, the output signal is configured to one or more of adjust a navigation action, cause retrieval over a communications network of a response signal, cause retrieval over the communications network of vehicle environment information, or cause sending of a communication signal over the communications network to a target vehicle.

Instead of in vehicles, example systems or techniques according to the disclosure may be implemented in non-vehicular systems, for example, hand-held devices, wearable devices, computing devices, or the like.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer system-readable medium, such as a computer system-readable storage medium, containing instructions. Instructions embedded or encoded in a computer system-readable medium, including a computer system-readable storage medium, may cause one or more programmable processors, or other processors, to implement one or more of the techniques described herein, such as when instructions included or encoded in the computer system-readable medium are executed by the one or more processors. Computer system readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer system readable media. In some examples, an article of manufacture may comprise one or more computer system-readable storage media.

### EXAMPLES

### Example 1

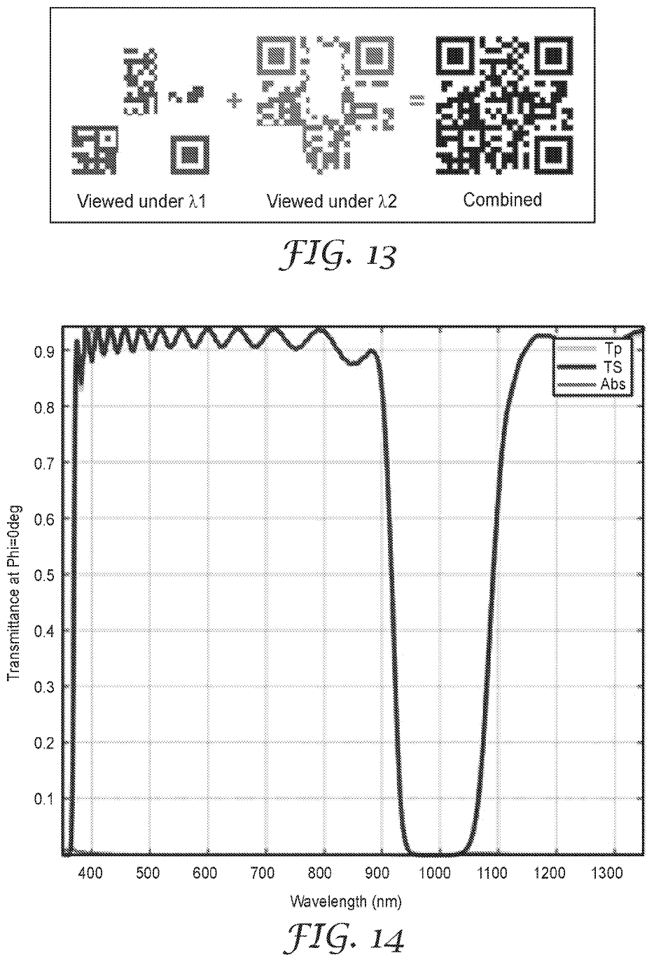

A prophetic example of a coded pattern is described. FIG. 13 is a conceptual diagram of a coded pattern readable by a vehicle assistance system. The pattern includes two compositions together defining a two-dimensional (2D) QR barcode. The first composition includes a first dye having a transition edge at a first wavelength λ₁. The second composition includes a second dye having a transition edge at a second wavelength λ₂, higher than λ₁. When the pattern is illuminated or viewed under small wavelength ranges, a computing device receiving image data from an image sensor imaging the pattern under λ₁ and λ₂ can detect that the composite code is actually made of two separate codes as shown in FIG. 13. The computing device can combine the two separate codes to generate the combined pattern, and detect information from the combined pattern.

### Example 2

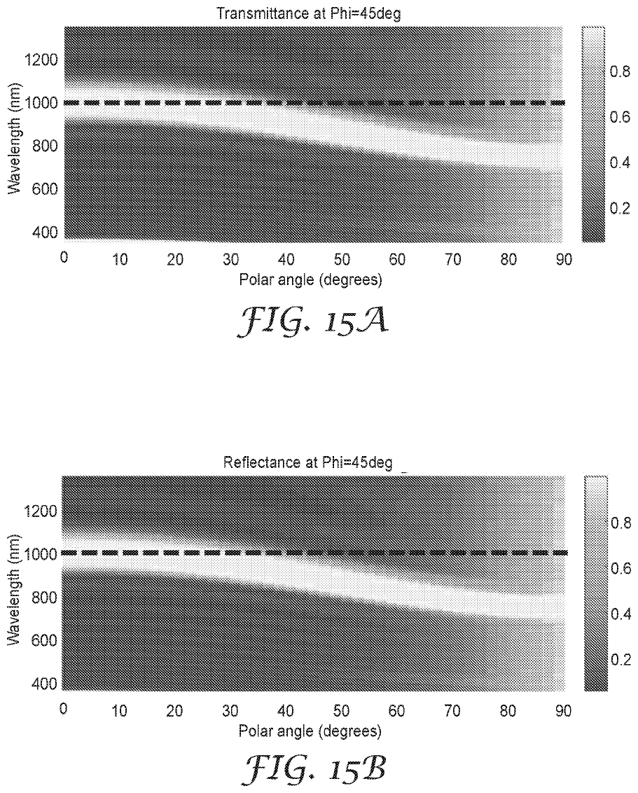

A prophetic example of an optically-selective element is described. A narrow band blocking multilayer optical film (MOF) having 1st order reflection centered at 1000 nm, with the 2nd order reflection tuned out is used. The bandwidth is tuned between 50 nm and 200 nm. FIG. 14 is a chart showing a spectrum of an example narrow band blocking multilayer optical film (MOF). FIG. 15A is a chart showing a relationship between wavelength, polar angle, and reflectance of the MOF of FIG. 14 in air. FIG. 15B is a chart showing a relationship between wavelength, polar angle, and transmittance of the MOF of FIG. 14 in air. The acceptance angle is ±40°.

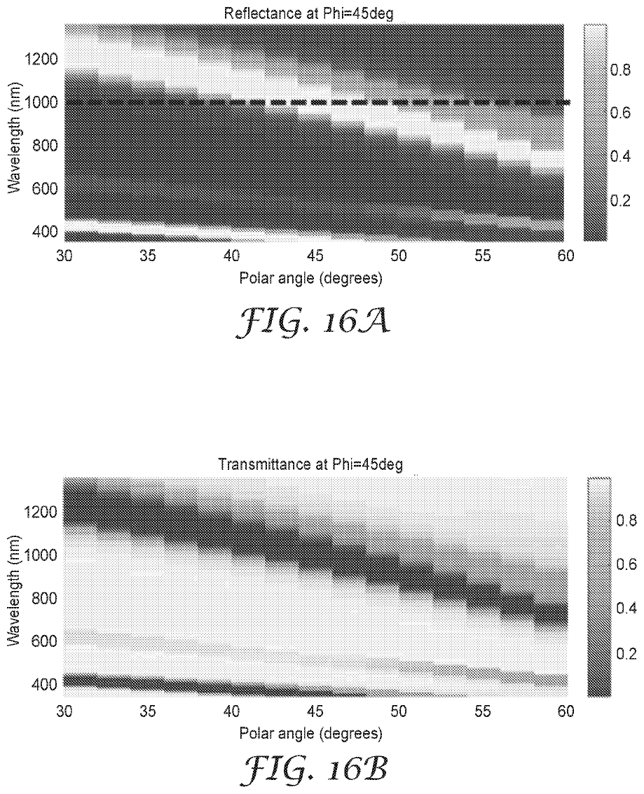

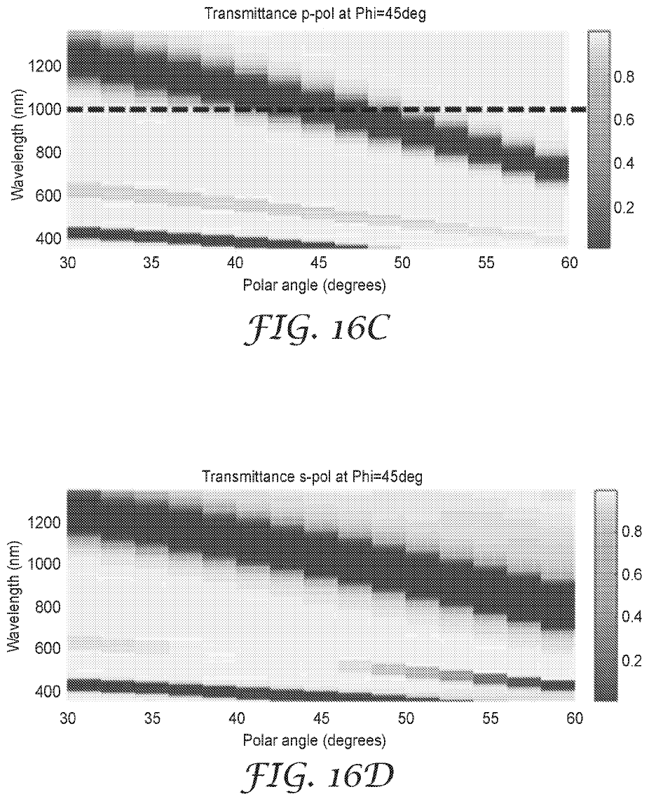

FIG. 16A is a chart showing a relationship between wavelength, polar angle, and reflectance of the MOF of FIG. 14 in glass (a glass beamsplitter cube). FIG. 16B is a chart showing a relationship between wavelength, polar angle, and transmittance of the MOF of FIG. 14 in glass. FIG. 16C is a chart showing a relationship between wavelength, polar angle, and p-polarized transmittance of the MOF of FIG. 14 in glass. FIG. 16D is a chart showing a relationship between wavelength, polar angle, and s-polarized transmittance of the MOF of FIG. 14 in glass. Light is incident at 45°±15° cone in the cube. This shows a high angle shift and therefore a need for a collimation optic to limit the angle of incidence of the light on the film.

### Example 3

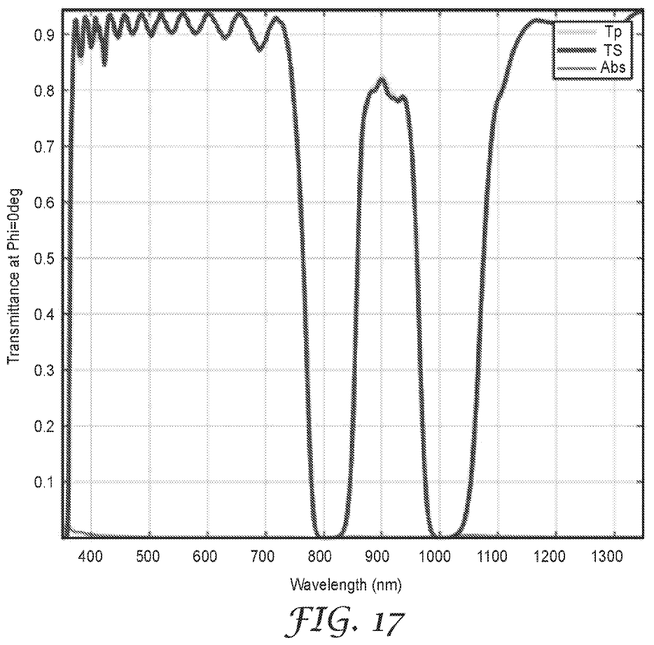

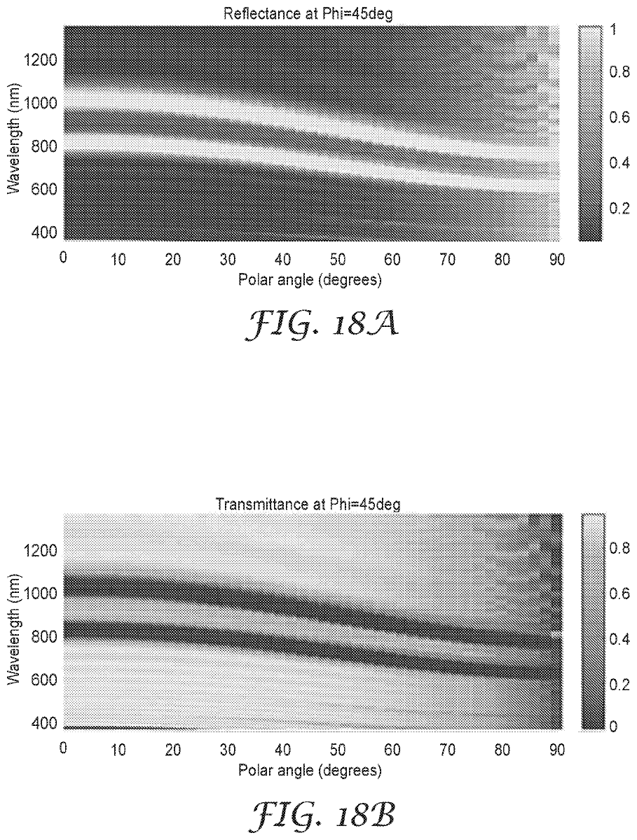

A prophetic example of a dual-band optically-selective element is described. The element includes a filter made by laminating two multilayer optical films (MOFs) having respective single bands, at 800 nm and 1000 nm. Multibands between 350 nm and 1000 nm or more can be used. FIG. 17 is a chart showing a spectrum of an example dual band blocking multilayer optical film (MOF). FIG. 18A is a chart showing a relationship between wavelength, polar angle, and reflectance of the MOF of FIG. 17 in air. FIG. 18B is a chart showing a relationship between wavelength, polar angle, and transmittance of the MOF of FIG. 17 in air. The two bands are independently tunable.

Various examples of the invention have been described. These and other examples are within the scope of the following claims.

1. A vehicle assistance system comprising:
a light sensor;
a pixelated filter array adjacent the light sensor; and
a full-field optically-selective element adjacent the pixelated filter array, wherein the optically-selective element is configured to selectively direct an optical component of light incident on the optically-selective element through the pixelated filter array to the light sensor.

2. The system of claim 1, wherein the pixelated filter array comprises at least one clear pixel.

3. The system of claim 1, wherein the pixelated filter array consists of a plurality of clear pixels.

4. The system of claim 1, wherein the pixelated filter array comprises a Bayer color filter array (BCFA), a red/clear color filter array (RCCC), a red/clear blue color filter array (RCCB), or a monochrome array.

5. The system of claim 1, wherein the full-field optically-selective element comprises an angle-limiting optical element.

6. The system of claim 1, wherein the full-field optically-selective element comprises an angle-spreading optical element.

7. The system of claim 1, wherein the full-field optically-selective element comprises a curved multilayer optical film.

8. The system of claim 1, wherein the full-field optically-selective element comprises at least one of an ultraviolet-(UV) transmitting, visible-reflecting multilayer film filter; an ultraviolet-(UV) reflecting, visible-transmitting multilayer film filter; an edge filter; a transmission notch filter; a reflective notch filter; or a multiband filter.

9. The system of claim 1, wherein the full-field optically-selective element comprises a beamsplitter.

10. The system of claim 9, wherein the full-field optically-selective element further comprises at least one lens adjacent the beamsplitter.

11. The system of claim 9, wherein the full-field optically-selective element further comprises at least one inclined mirror adjacent the beamsplitter.

12. The system of claim 11, wherein the beamsplitter comprises a polarization beamsplitter, a wavelength beamsplitter, a dichroic prism, a trichroic prism, or combinations thereof.

13. The system of claim 1, further comprising at least one lens-like element adjacent the light sensor configured to transmit substantially parallel rays to the light sensor.

14. The system of claim 1, further comprising a light transmitter configured to transmit light towards an object, and wherein the light sensor is configured to sense light reflected or retroreflected by the object from the light transmitter.

15. The system of claim 1, further comprising at least one optical element configured to direct light from the full-field optically-selective element to the light sensor.

16. The system of claim 1, comprising at least one polarizing filter across an optical path arriving at the light sensor.

17. The system of claim 1, wherein the light sensor comprises a first light sensor, wherein the pixelated filter array comprises a first pixelated filter array, wherein the system further comprises a second light sensor, wherein the optical component is a first optical component, wherein the system further comprises a second pixelated filter array, and wherein the full-field optically-selective element is configured to selectively direct a second optical component of light incident on the optically-selective element across the second pixelated filter array to the second light sensor.

18. The system of claim 17, wherein the first optical component comprises at least a first ultraviolet, visible, or infrared wavelength band, and wherein the second optical component comprises at least a second ultraviolet, visible, or infrared band different from the first band.

19. The system of claim 18, wherein the first wavelength band has a bandwidth less than 200 nm, and wherein the second wavelength band comprises the spectral complement of the first wavelength band.

20. The system of claim 17, wherein the first wavelength band comprises at least one visible wavelength band, and wherein the second wavelength band comprises at least one near-infrared band.

21. The system of claim 17, wherein the first wavelength band comprises at least one visible wavelength band and at least a first near-infrared band, and wherein the second wavelength band comprises at least a second near-infrared band.

22. The system of claim 17, wherein the first wavelength band comprises at least one visible wavelength band, and wherein the second wavelength band comprises at least one UV band.

23. The system of claim 17, wherein the first wavelength band comprises at least a first one visible wavelength band, and wherein the second wavelength band comprises at least a second visible wavelength band.

24. The system of claim 17, wherein the first optical component comprises a first polarization state, and wherein the second optical component comprises at least a second polarization state different from the first polarization state.

25. The system of claim 17, wherein the first light sensor comprises an imaging sensor, and wherein the second light sensor comprises a hyperspectral sensor.

26. The system of claim 1, further comprising a retarder adjacent the full-field optically-selective element.

27. The system of claim 1, further comprising an enclosure, wherein the light sensor, pixelated filter array, and full-field optically-selective element are secured adjacent to each other in the enclosure, and wherein the enclosure defines at least one optical window to admit light.

28. The system of claim 1, further comprising a computing device configured to receive an image data signal from the image sensor, wherein the computing device comprises:
a memory comprising a lookup table comprising a plurality of reference images; and
a processor configured to compare the image data signal with the plurality of reference images and generate an output signal in response to the comparison.

29. The system of claim 28, wherein the output signal is configured to one or more of adjust a navigation action, cause retrieval over a communications network of a response signal, cause retrieval over the communications network of vehicle environment information, or cause sending of a communication signal over the communications network to a target vehicle.

30. The system of claim 1, comprising an advanced driver-assistance system (ADAS).

31. A vehicle for land, water, or air comprising the system of claim 1.

32. A method comprising
receiving, by a full-field optically-selective element of a vehicle assistance system, a light signal from an object; and
selectively directing, by the full-field optically-selective element, an optical component of the light signal through a pixelated filter array to a light sensor.

33. The method of claim 32, further comprising:
receiving, by a computing device, an image data signal from the image sensor in response to the light signal;
comparing, by the computing device, the image data signal with a plurality of reference images in a lookup table; and
generating, by the computing device, in response to the comparison, an output signal.

34. The method of claim 33, wherein the output signal is configured to one or more of adjust a navigation action, cause retrieval over a communications network of a response signal, cause retrieval over the communications network of vehicle environment information, or cause sending of a communication signal over the communications network to a target vehicle.
